(19) United States
(12) Patent Application Publication
(10) Pub. No.: US 2024/0298315 A1
(43) Pub. Date: Sep. 5, 2024

(54) USER EQUIPMENT MODIFICATION TO A CONFIGURED GRANT RETRANSMISSION TIMER

(71) Applicant: QUALCOMM Incorporated, San Diego, CA (US)

(72) Inventors: Diana MAAMARI, San Diego, CA (US); Mickael MONDET, Louannec (FR); Ozcan OZTURK, San Diego, CA (US); Prashanth Haridas HANDE, San Diego, CA (US); Linhai HE, San Diego, CA (US); Ahmed ELSHAFIE, San Diego, CA (US); Hyun Yong LEE, San Diego, CA (US); Huilin XU, Temecula, CA (US)

(21) Appl. No.: 18/177,401

(22) Filed: Mar. 2, 2023

(51) Int. Cl. H04W 72/1263; H04L 1/08; H04L 1/1812; H04W 72/21

(52) U.S. Cl. CPC H04W 72/1263; H04L 1/08; H04L 1/1812; H04W 72/21

(57) ABSTRACT

Various aspects of the present disclosure generally relate to wireless communication. In some aspects, a user equipment (UE) may receive a first indication of a configuration for a configured grant retransmission timer that is associated with a configured grant assigned to the UE. The UE may determine a modification to the configuration for the configured grant retransmission timer based at least in part on a remaining uplink delay budget. The UE may transmit a second indication of the modification. Numerous other aspect are described.

### FIELD OF THE DISCLOSURE

Aspects of the present disclosure generally relate to wireless communication and to techniques and apparatuses for a user equipment (UE) modification to a configured grant retransmission timer.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first indication of a configuration for a configured grant retransmission timer that is associated with a configured grant assigned to the UE. The method may include determining a modification to the configuration for the configured grant retransmission timer based at least in part on a remaining uplink delay budget. The method may include transmitting a second indication of the modification.

Some aspects described herein relate to a method of wireless communication performed by a network node. The method may include transmitting a first indication of a configuration for a configured grant retransmission timer that is associated with a configured grant assigned to a UE. The method may include receiving a second indication of a modification to the configuration for the configured grant retransmission timer.

Some aspects described herein relate to an apparatus for wireless communication at a UE. The apparatus may include a memory and one or more processors coupled to the memory. The one or more processors may be configured to cause the UE to receive a first indication of a configuration for a configured grant retransmission timer that is associated with a configured grant assigned to the UE. The one or more processors may be configured to cause the UE to determine a modification to the configuration for the configured grant retransmission timer based at least in part on a remaining uplink delay budget. The one or more processors may be configured to cause the UE to transmit a second indication of the modification.

Some aspects described herein relate to an apparatus for wireless communication at a network node. The apparatus may include a memory and one or more processors coupled to the memory. The one or more processors may be configured to cause the network node to transmit a first indication of a configuration for a configured grant retransmission timer that is associated with a configured grant assigned to a UE. The one or more processors may be configured to cause the network node to receive a second indication of a modification to the configuration for the configured grant retransmission timer.

Some aspects described herein relate to a non-transitory computer-readable medium that stores a set of instructions for wireless communication by a UE. The set of instructions, when executed by one or more processors of the UE, may cause the UE to receive a first indication of a configuration for a configured grant retransmission timer that is associated with a configured grant assigned to the UE. The set of instructions, when executed by one or more processors of the UE, may cause the UE to determine a modification to the configuration for the configured grant retransmission timer based at least in part on a remaining uplink delay budget. The set of instructions, when executed by one or more processors of the UE, may cause the UE to transmit a second indication of the modification.

Some aspects described herein relate to a non-transitory computer-readable medium that stores a set of instructions for wireless communication by a network node. The set of instructions, when executed by one or more processors of the network node, may cause the network node to transmit a first indication of a configuration for a configured grant retransmission timer that is associated with a configured grant assigned to a UE. The set of instructions, when executed by one or more processors of the network node, may cause the network node to receive a second indication of a modification to the configuration for the configured grant retransmission timer.

Some aspects described herein relate to an apparatus for wireless communication. The apparatus may include means for receiving a first indication of a configuration for a configured grant retransmission timer that is associated with a configured grant assigned to the UE. The apparatus may include means for determining a modification to the configuration for the configured grant retransmission timer based at least in part on a remaining uplink delay budget. The apparatus may include means for transmitting a second indication of the modification.

Some aspects described herein relate to an apparatus for wireless communication. The apparatus may include means for transmitting a first indication of a configuration for a configured grant retransmission timer that is associated with a configured grant assigned to a UE. The apparatus may include means for receiving a second indication of a modification to the configuration for the configured grant retransmission timer.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of uplink configured grant (CG) communication, in accordance with the present disclosure.

FIG. 4 is a diagram illustrating an example of a configured grant timer and a configured grant retransmission timer, in accordance with the present disclosure.

FIG. 5 is a diagram illustrating an example of a wireless communication process between a UE and a network node, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Some operations at a user equipment (UE) may be sensitive and/or susceptible to longer data transfer latencies. To illustrate, an uplink data transmission associated with a Quality-of-Service (QoS) flow may be configured with a high priority level and/or a low data transfer latency bound. A configured grant (CG) may include a CG timer and/or a CG retransmission timer that contributed to the UE failing to meet the high priority level and/or low data transfer latency bound, resulting in the UE failing to support time sensitive operations. For example, the CG timer and/or the CG retransmission timer may prevent the UE from transmitting multiple different data packets in succession based at least in part on the UE waiting for a retransmission process to complete.

Some techniques and apparatuses described herein provide a UE modification to a configured grant retransmission timer. In some aspects, a UE (e.g., the UE 120) may autonomously select a modification and/or reconfiguration for a CG retransmission timer that is associated with a CG assigned to the UE. The UE may select the modification and/or reconfiguration based at least in part on determining that a current configuration of the CG retransmission will result in the UE failing to satisfy a data transfer latency bound. At times, the UE may indicate the modification to a network node and/or communicate with the network node using one or more occasions of the CG and the modification to the CG retransmission timer.

By transmitting a modification to a CG retransmission timer, a UE may mitigate an uplink transmission delay that exceeds a data transfer latency bound for operations that may be time sensitive. To illustrate, the modification may include shortening a periodicity of the CG retransmission timer and/or terminating the CG retransmission timer. As described below, modifying the CG retransmission timer may enable the UE to reduce an uplink data transfer delay, to meet a data transfer latency bound, and/or to support time sensitive operations.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

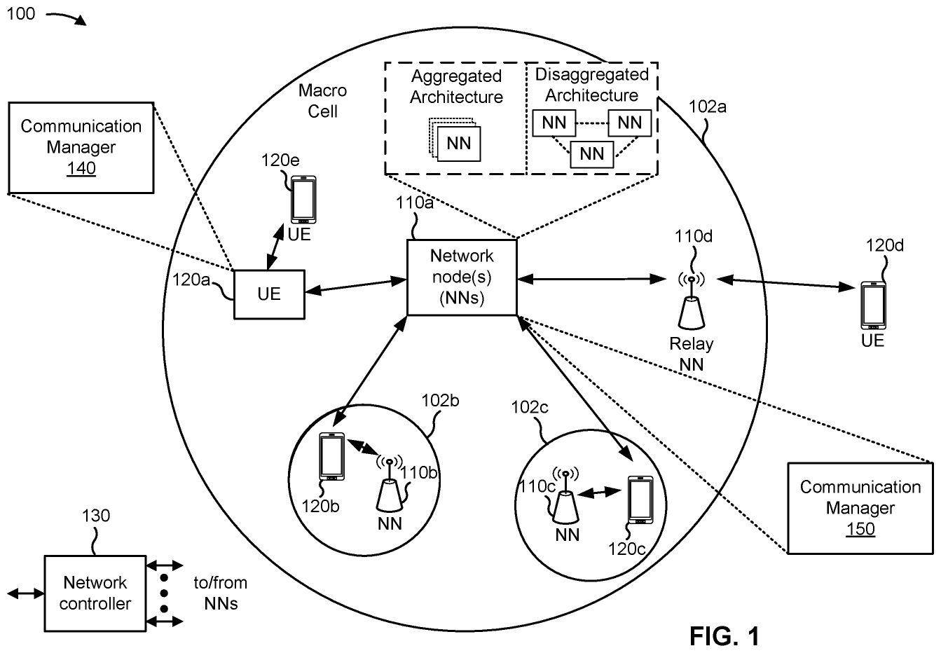

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive a first indication of a configuration for a configured grant retransmission timer that is associated with a configured grant assigned to the UE; determine a modification to the configuration for the configured grant retransmission timer based at least in part on a remaining uplink delay budget; and transmit a second indication of the modification. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a first indication of a configuration for a configured grant retransmission timer that is associated with a configured grant assigned to a UE; and receive a second indication of a modification to the configuration for the configured grant retransmission timer. Additionally, or alternatively, the communication manager 150 may perform one or more other operations described herein.

As indicated above, FIG. 1 is provided as an example. Other examples may differ from what is described with regard to FIG. 1.

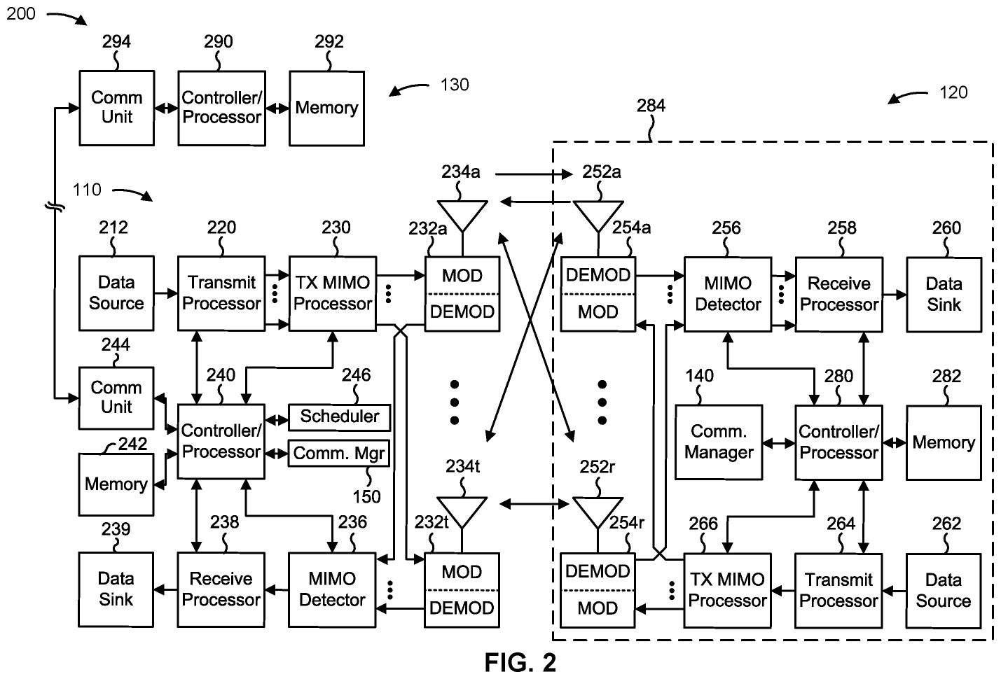

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

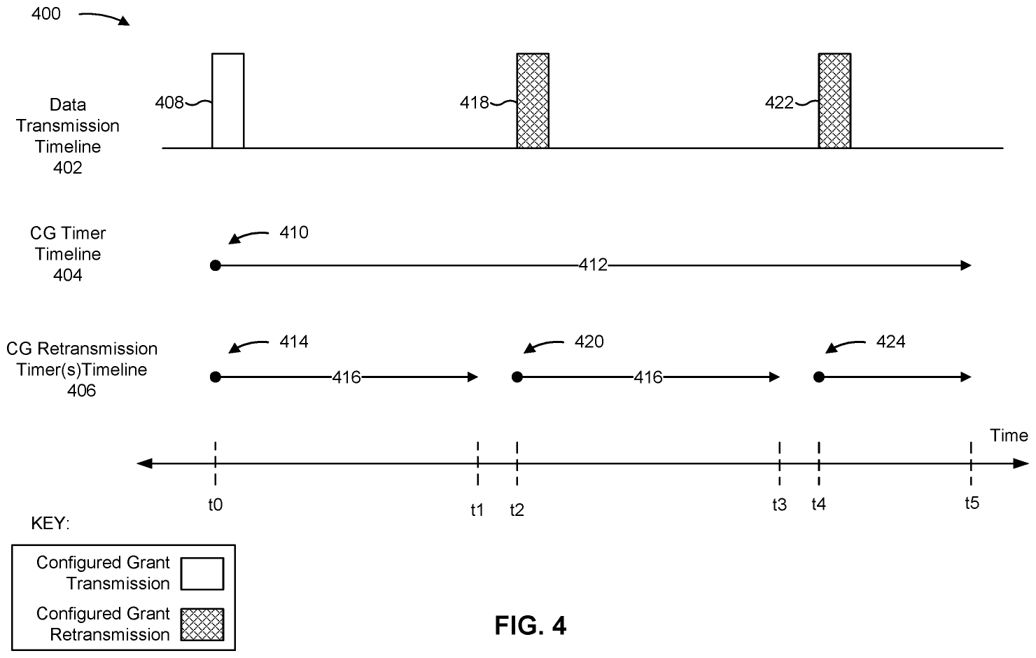

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

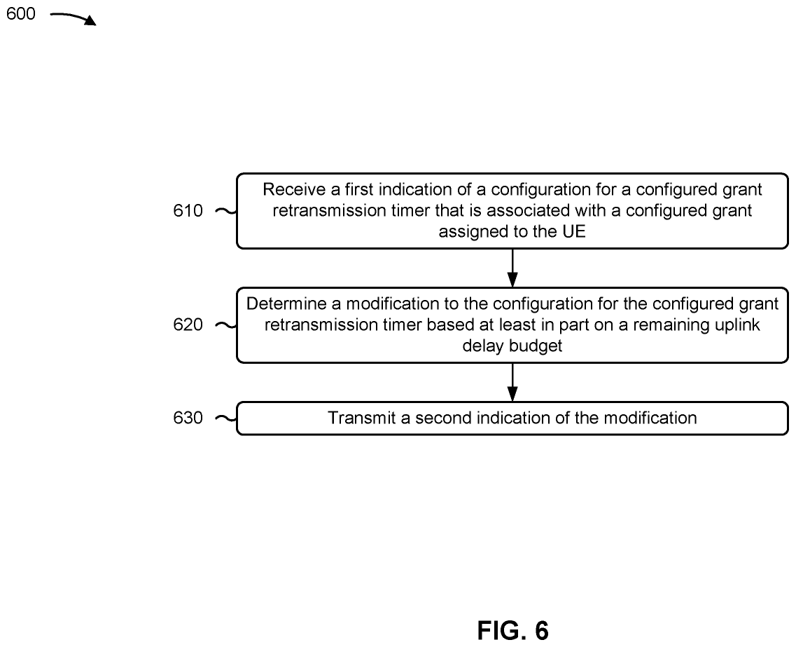

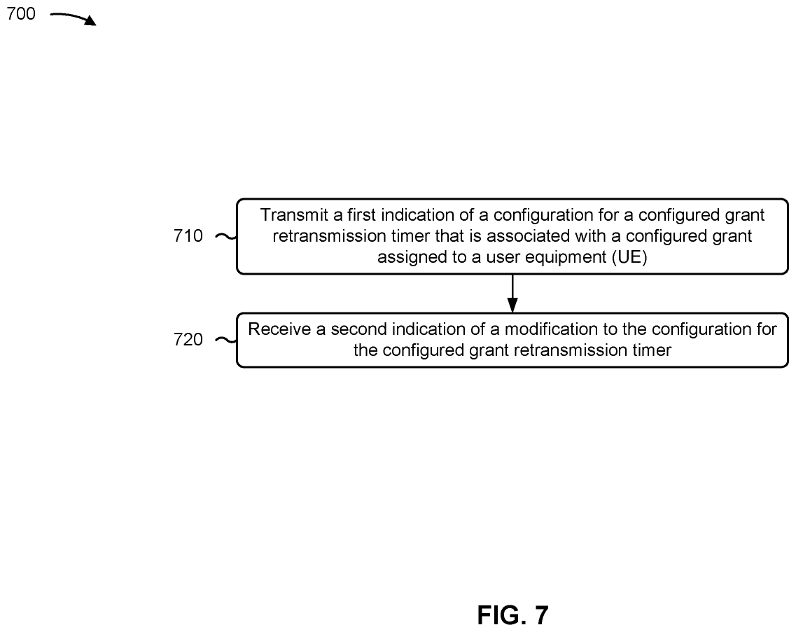

The controller/processor 240 of the network node 110, the controller/processor 280 of the UE 120, and/or any other component(s) of FIG. 2 may perform one or more techniques associated with a UE modification to a CG retransmission timer, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a first indication of a configuration for a configured grant retransmission timer that is associated with a configured grant assigned to the UE; means for determining a modification to the configuration for the configured grant retransmission timer based at least in part on a remaining uplink delay budget; and/or means for transmitting a second indication of the modification. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a first indication of a configuration for a configured grant retransmission timer that is associated with a configured grant assigned to a UE; and/or means for receiving a second indication of a modification to the configuration for the configured grant retransmission timer. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

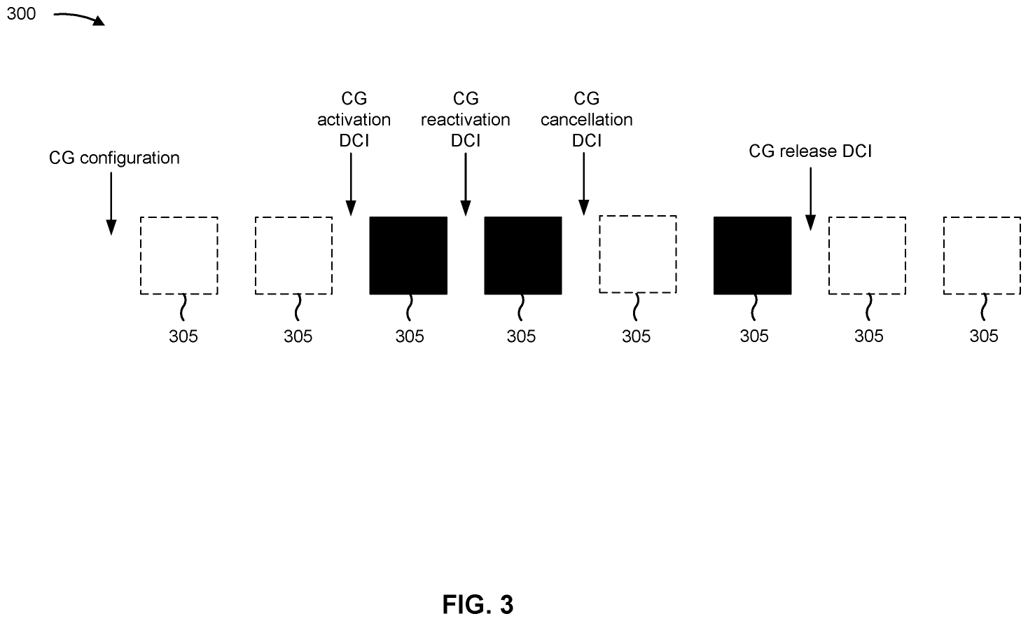

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the FIG. 3 is a diagram illustrating an example 300 of uplink CG communication, in accordance with the present disclosure. CG communications may include periodic uplink communications that are configured for a UE, such that the network node does not need to send separate downlink control information (DCI) to schedule each uplink communication, thereby conserving signaling overhead.

As shown in example 300, a UE may be configured with a CG configuration for CG communications. For example, the UE may receive the CG configuration via a radio resource control (RRC) message transmitted by a network node. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 305 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

In a Type 1 CG, the network node may implicitly indicate CG activation and/or CG deactivation to the UE using RRC signaling, such as by transmitting an indication of the CG configuration. In a Type 2 CG, the network node may transmit, in addition to transmitting the CG configuration, signaling to activate and/or deactivate use of the CG. To illustrate, for a Type 2 CG and as shown by FIG. 3, the network node may transmit CG activation DCI to the UE to activate the CG configuration for the UE. The network node may indicate, in the CG activation DCI, communication parameters, such as an MCS, a resource block (RB) allocation, and/or antenna ports, for the CG physical uplink shared channel (PUSCH) communications to be transmitted in the scheduled CG occasions 305. The UE may begin transmitting in the CG occasions 305 based at least in part on receiving the CG activation DCI. For example, beginning with a next scheduled CG occasion 305 subsequent to receiving the CG activation DCI, the UE may transmit a PUSCH communication in the scheduled CG occasions 305 using the communication parameters indicated in the CG activation DCI. The UE may refrain from transmitting in configured CG occasions 305 prior to receiving the CG activation DCI.

Alternatively, or additionally, the network node may transmit CG reactivation DCI to the UE to change the communication parameters for the CG PUSCH communications. Based at least in part on receiving the CG reactivation DCI, and the UE may begin transmitting in the scheduled CG occasions 305 using the communication parameters indicated in the CG reactivation DCI. For example, beginning with a next scheduled CG occasion 305 subsequent to receiving the CG reactivation DCI, the UE may transmit PUSCH communications in the scheduled CG occasions 305 based at least in part on the communication parameters indicated in the CG reactivation DCI.

In some cases, such as when the network node needs to override a scheduled CG communication for a higher priority communication, the network node may transmit CG cancellation DCI to the UE to temporarily cancel or deactivate one or more subsequent CG occasions 305 for the UE. The CG cancellation DCI may deactivate only a subsequent one CG occasion 305 or a subsequent N CG occasions 305 (where N is an integer). CG occasions 305 after the one or more (e.g., N) CG occasions 305 subsequent to the CG cancellation DCI may remain activated. Based at least in part on receiving the CG cancellation DCI, the UE may refrain from transmitting in the one or more (e.g., N) CG occasions 305 subsequent to receiving the CG cancellation DCI. As shown in example 300, the CG cancellation DCI cancels one subsequent CG occasion 305 for the UE. After the CG occasion 305 (or N CG occasions) subsequent to receiving the CG cancellation DCI, the UE may automatically resume transmission in the scheduled CG occasions 305.

The network node may transmit CG release DCI to the UE to deactivate the CG configuration for the UE. The UE may stop transmitting in the scheduled CG occasions 305 based at least in part on receiving the CG release DCI. For example, the UE may refrain from transmitting in any scheduled CG occasions 305 until another CG activation DCI is received from the network node. Whereas the CG cancellation DCI may deactivate only a subsequent one CG occasion 305 or a subsequent N CG occasions 305, the CG release DCI deactivates all subsequent CG occasions 305 for a given CG configuration for the UE until the given CG configuration is activated again by a new CG activation DCI.

As indicated above, FIG. 3 is provided as an example. Other examples may differ from what is described with respect to FIG. 3.

FIG. 4 is a diagram illustrating an example 400 of a CG timer and a CG retransmission timer, in accordance with the present disclosure.

“Hybrid automatic repeat request (HARQ)” may denote a protocol in which a receiving device that detects errors and/or corruption in a message (e.g., bit errors that satisfy an error threshold) may attempt to correct the errors and/or request a retransmission of the message, either implicitly or explicitly. To illustrate, the receiving device may transmit a HARQ acknowledgement (ACK) to indicate the message was received with an acceptable number of errors and a HARQ negative acknowledgement (NACK) to indicate the message was not received successfully. If the transmitting device does not receive the HARQ ACK before expiration of a timer and/or receives the HARQ NACK, the transmitting device may retransmit the message. Accordingly, a HARQ process may be a process the transmission, reception, and/or retransmission of a data packet based at least in part on the HARQ protocol.

For a CG uplink transmission as described with regard to FIG. 3, a UE (e.g., the UE 120) may perform retransmissions based at least in part on a CG timer and/or a CG retransmission timer. In some aspects, a CG timer may be used by the UE to monitor and/or regulate the transmission (and reception) of a data packet. For example, the CG timer may prevent the UE from updating a HARQ buffer with a new outgoing data packet until a current data packet has been successfully received or the CG timer has expired. Alternatively, or additionally, the CG timer may limit a number of retransmissions that may be performed for a data packet. A CG retransmission timer may be used by the UE to monitor and/or regulate when a retransmission of a data packet may be performed.

In some aspects, the CG timer and the CG retransmission timer are maintained per HARQ process (e.g., for a same HARQ process). With regard to the CG timer, a UE may not stop and/or terminate a CG timer upon reception of a HARQ NACK, but may stop the CG timer upon receipt of a HARQ ACK. With regard to the CG retransmission timer, the UE may refrain from autonomous retransmission of a data packet on a CG resource while the related CG retransmission timer is running and/or has not expired. That is, autonomous retransmission may be prohibited for the duration of the CG retransmission timer. Upon expiration of a CG timer, the UE may stop and/or terminate the CG retransmission timer.

A duration of a CG timer may be configured per configured grant configuration. Alternatively, or additionally, a duration of a CG retransmission timer may be configured per CG configuration. To illustrate, a network node may indicate a first value for the CG timer duration and/or a second value for the CG retransmission timer in CG configuration information. In some aspects, the second value and/or second duration of the CG retransmission timer may be shorter than the first value and/or first duration associated with the CG timer and/or based at least in part on an integer multiple of a periodicity M, such as M, 2M, 3M, up to XM (where X is an integer).

The example 400 includes a data transmission timeline 402, a CG timer timeline 404, and a CG retransmission timer timeline 406. For each timeline, a horizontal axis represents time. The data transmission timeline 402 may be associated with a data transmission and/or data retransmissions by a UE, the CG timer timeline 404 may be associated with a CG timer at the UE, and the CG retransmission timer timeline 406 may be associated with one or more CG retransmission timers at the UE.

As shown by FIG. 4, at time t0, the UE may transmit a data packet 408 (shown in solid white) to a receiving device (e.g., a network node via an uplink or another UE via a sidelink). To illustrate, the UE may transmit the data packet 408 using air interface resources of a first CG uplink occasion as described with regard to FIG. 3. As shown by reference number 410, the UE may also start a CG timer at time t0. The CG timer may be configured to expire after a first duration 412. Accordingly, until expiration of the CG timer or reception of a HARQ ACK, the UE may prevent a HARQ buffer from being over-written with new data and/or may refrain from transmitting a second, different data packet. Alternatively, or additionally, and as shown by reference number 414, the UE may start a first CG retransmission timer that has a second duration 416.

At time t1, the first CG retransmission timer may expire. Based at least in part on expiration of the first CG retransmission timer, the UE may identify and/or determine that the receiving device received the data packet 408 with errors and/or that the receiving device failed to receive the data packet 408. As one example, the UE may determine that the receiving device failed to receive the data packet 408 based at least in part on expiration of the first CG retransmission timer and failing to receive either a HARQ ACK or a HARQ NACK. As another example, the UE may receive the HARQ NACK while the first CG retransmission timer is running and/or has not expired.

Prior to expiration of the CG timer, the UE may transmit a first retransmission 418 (shown with a crisscross pattern) of the data packet 408 at time t2. That is, the first retransmission 418 may include a same data packet as the data packet 408, and the UE may transmit the first retransmission 418 using air interface resources associated with a second CG uplink occasion. Alternatively, or additionally, and as shown by reference number 420, the UE may initiate and/or start a second CG retransmission timer that is configured to expire after the second duration 416. At time t3, the second CG retransmission timer may expire, and the UE may identify and/or determine that the receiving device received the first retransmission 418 with errors and/or failed to receive the first retransmission 418. Accordingly, and based at least in part on the CG timer continuing and/or not expiring, the UE may transmit a second retransmission 422 at time t4. As shown by reference number 424, the UE may also initiate and/or start a third CG retransmission timer at time t4. At time t5, the CG timer expires and, based at least in part on expiration of the CG timer, the UE may terminate the third CG retransmission timer as described above. Accordingly, the UE may refrain from sending any additionally retransmissions that are based at least in part on the data packet 408.

Varying factors may contribute to an uplink data transfer latency experienced by the UE. As one example, a protocol stack at the UE may include a packet data convergence (PDCP) layer to receive and prepare user data transmissions. The PDCP layer may include an uplink PDCP queue for storing one or more data packets waiting to be transmitted by the UE. At times, the uplink PDCP queue may introduce a wait time that the UE experiences and/or observes as part of an uplink data transfer latency. To illustrate, the uplink PDCP queue may store one or more data packets and/or delay transmission of the data packet(s) while the UE waits for a HARQ ACK, expiration of a CG timer, and/or expiration of a CG retransmission timer.

In some aspects, operations at the UE may be sensitive and/or susceptible to longer data transfer latencies. To illustrate, the uplink data transmissions may be associated with a QoS flow configured with a high priority level and/or a low data transfer latency bound that the uplink data transfer latency experienced by the UE fails to satisfy. Some non-limiting examples may include QoS flows associated with extended reality (XR), video and/or audio calls, ultra-reliable low-latency communications (URLLCs), autonomous driving, remote control of a non-terrestrial device, and/or navigation. Although the CG retransmission timer may be configured based at least in part on a multiple of a periodicity, the network node configuring a duration of the CG retransmission timer may be unaware of the added wait time at the UE and may select a duration for the CG retransmission timer that results in the UE failing to meet the high priority level and/or low data transfer latency metrics of the QoS flow (and/or other operations). The UE may be unable to modify the CG retransmission timer configured by the network node and mitigate the uplink data transfer latency, also resulting in UE failing to meet the specified high priority level and/or low data transfer latency metrics.

Some techniques and apparatuses described herein provide a UE modification to a configured grant retransmission timer. In some aspects, a UE (e.g., the UE 120) may receive a first indication of a configuration for a CG retransmission timer that is associated with a CG assigned to the UE. The UE may determine a modification to the configuration for the CG retransmission timer based at least in part on a remaining uplink delay budget, such as a first modification to terminate the CG retransmission timer and/or a second modification to shorten a duration of the CG retransmission timer. As one non-limiting example, the UE may receive an update to at least a QoS configuration (e.g., a priority level, a latency limit, an error rate, and/or a bit rate) associated with a QoS flow, such as by receiving an indication of a 5G QoS identifier (5QI) value. Based at least in part on determining the modification, the UE may transmit a second indication of the modification (e.g., to a network node).

By transmitting a modification to a CG retransmission timer, a UE may mitigate an uplink transmission delay that exceeds a data transfer latency bound for operations that may be time sensitive. To illustrate, shortening a periodicity of the CG retransmission timer and/or terminating the CG retransmission timer may also result in the UE shortening a duration of the CG timer and/or transmitting a second, different data packet instead of transmitting a first data packet. That is, the UE may reduce the uplink data transfer delay associated with the second, different data packet. Accordingly, mitigating the uplink transmission delay may enable the UE to meet a data transfer latency bound and support time sensitive operations.

As indicated above, FIG. 4 is provided as an example. Other examples may differ from what is described with regard to FIG. 4.

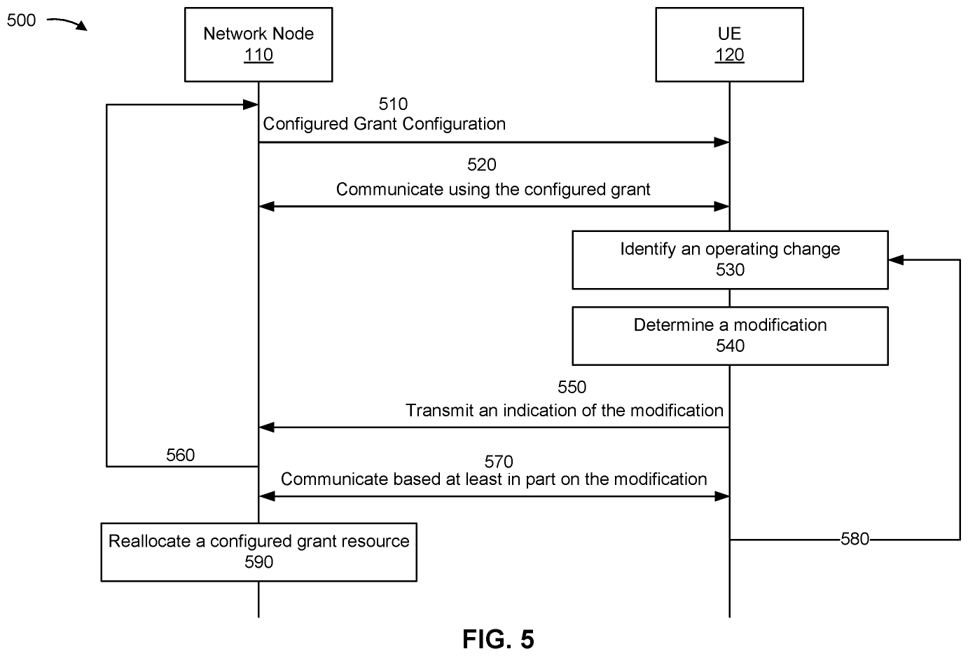

FIG. 5 is a diagram illustrating an example 500 of a wireless communication process between a UE (e.g., the UE 120) and a network node (e.g., the network node 110), in accordance with the present disclosure.

As shown by reference number 510, the network node 110 may transmit, and the UE 120 may receive, a first indication of a CG configuration that is associated with a CG assigned to the UE. To illustrate, the network node 110 may transmit an indication of a frequency domain allocation of the CG, a time domain allocation of the CG, a first CG timer duration, and/or a first CG retransmission timer duration. Alternatively, or additionally, the network node 110 may indicate a set of CG retransmission timer periodicities to the UE 120, either as part of the CG configuration or in a separate transmission. For instance, the network node 110 may indicate a different value of M for each CG retransmission timer periodicity in the set. The set of CG retransmission timer periodicities may be used by the UE 120 to select a modification to a CG retransmission timer as described below. In some aspects, and as part of configuring the UE 120 with a CG, the network node 110 may configure the UE 120 with the CG retransmission timer and without an uplink HARQ retransmission timer. Configuring the UE 120 without a separate uplink HARQ retransmission timer may implicitly indicate, to the UE 120, to use the CG retransmission timer as the uplink HARQ retransmission timer and/or to configure a separate uplink HARQ retransmission timer with a same duration as the CG retransmission timer. In other aspects, the network node 110 may instruct the UE 120 to use the CG retransmission timer without using a separate HARQ retransmission timer. Configuring the UE 120 without a HARQ retransmission timer may reduce the number of times the UE 120 wakes up for unnecessary monitoring of retransmissions, such as unnecessary monitoring when the UE 120 and the network node 110 are communicating in an environment with high SNR. Reducing the number of times the UE 120 wakes up may preserve and/or extend a battery life of the UE 120.

As shown by reference number 520, the network node 110 and the UE 120 may communicate with one another based at least in part on the CG. As one example, for a Type 1 CG, the UE 120 may transmit one or more uplink transmissions using one or more uplink occasions associated with the CG and without receiving an explicit and/or separate activation instruction from the network node 110. As another example, for a Type 2 CG, the network node 110 may transmit a CG activation DCI, and, based at least in part on receiving the CG activation DCI, the UE 120 may transmit one or more uplink transmissions using the one or more uplink occasions.

As shown by reference number 530, the UE 120 may identify an operating change. As one example of an operating change, the UE 120 may receive (e.g., from the network node 110) an update to at least one 5QI and/or QoS configuration that is associated with a QoS flow, such as a change to any combination of a priority level, a latency limit, an error rate, and/or a bit rate. Alternatively, or additionally, the UE 120 may detect the execution of an application and/or a change in an application mode at the UE 120 that changes the operating bounds at the UE 120 (e.g., changes a priority level, a latency limit, an error rate, and/or a bit rate). For example, the change in the application mode may include the activation of a video call, the activation of an augmented reality mode, the activation of a virtual reality mode, and/or the activation of a navigation mode that may reduce and/or shorten a latency limit and/or latency bound and/or increase a data throughput bound.

Alternatively, or additionally, based at least in part on identifying the operating change, the UE may evaluate an uplink delay budget, an experienced uplink latency delay, and/or a remaining uplink latency to determine whether to modify the CG retransmission timer. To illustrate, the UE may experience an internal uplink latency based at least in part on a delay and/or time span between an arrival of an uplink data packet at the PDCP protocol layer and/or the PDCP queue and when the uplink data packet is transmitted (e.g., when an uplink grant is available). Accordingly, the experienced uplink latency and/or experienced uplink latency delay by the UE may be an internal delay at the UE. The UE may compare the (internal) experienced uplink latency delay to an uplink delay budget (e.g., configured by the network node 110), such as by calculating a remaining uplink delay budget and/a remaining uplink latency in the uplink delay budget. For example, the UE may subtract the value of the experienced uplink latency delay from the value of the uplink delay budget to generate a remaining uplink delay budget and/or a remaining uplink latency. In some aspects, the UE may determine to modify the CG retransmission timer based at least in part on the remaining uplink delay budget not satisfying a latency threshold. That is, the remaining uplink delay budget may be too small to satisfy the latency threshold and/or may indicate that the uplink latency is too tight to meet a latency bound at the UE.

As another example, the UE 120 may calculate the remaining uplink latency based at least in part on two or more logical channels. To illustrate, the UE 120 may communicate with the network node 110 based at least in part on using multiple logical channels, and each logical channel may have a different latency bound. Accordingly, the UE may select the shortest and/or minimum latency bound associated with the multiple logical channels to ensure that the UE may meet all of the latency bounds that are associated with the multiple logical channels. That is, the UE may identify the smallest and/or shortest latency bound out of the multiple latency bounds to determine if the remaining uplink latency will enable the UE to satisfy the minimum latency bound and, subsequently, the other latency bounds that are longer. If the UE is unable to satisfy the minimum latency bound, the UE may determine to modify the CG retransmission timer.

In some aspects, the UE 120 may determine to modify the CG retransmission timer based at least in part on a quality metric (e.g., RSSI, RSRP, and/or a bit error rate). For instance, a quality metric that satisfies a quality threshold may indicate, to the UE 120, that retransmissions between the UE 120 and the network node 110 are less likely to occur. Accordingly, the UE 120 may determine to modify the CG retransmission timer in scenarios where the quality threshold is satisfied.

As shown by reference number 540, the UE 120 may determine a modification to the CG retransmission timer. As one example, the UE may determine to terminate and/or disable the CG retransmission timer based at least in part on a remaining uplink latency failing to satisfy a latency bound of an application, logical channel, and/or QoS flow. Alternatively, or additionally, the UE 120 may determine to terminate and/or disable the CG retransmission timer based at least in part on a quality metric satisfying a quality threshold. In other examples, the UE 120 may determine a change to a periodicity of the CG retransmission timer, such as in scenarios where the quality metric fails to satisfy the quality threshold. To illustrate, the UE 120 may determine to shorten or lengthen the duration of the periodicity associated with the CG retransmission timer based at least in part on a latency bound shortening or increasing, respectively, and/or the quality metric indicating that retransmissions between the UE 120 and the network node 110 are more likely. In some aspects, the UE 120 may determine to skip one or more uplink occasions associated with the CG. For instance, the UE 120 may determine to increase a duration to a periodicity of the CG retransmission timer and, subsequently, lengthen the periodicity by changing a decrement factor of the CG retransmission timer and/or by skipping one or more uplink occasions. Alternatively, or additionally, the UE 120 may indicate that the CG retransmission timer may be disabled, may be modified, has been disabled (e.g., by the UE 120), and/or has been modified (e.g., by the UE 120), such as by setting a field (e.g., a bit field) in uplink control information (UCI) and/or configured grant-uplink control information (CG-UCI) to a particular value (e.g., “1” or “0”). CG-UCI may be a type of UCI that is included in every CG PUSCH transmission.

The UE 120 may autonomously adapt and/or change a periodicity of the CG retransmission timer based at least in part on an experienced uplink delay, such as by selecting a periodicity that enables the UE to satisfy an uplink latency bound. In some aspects, the UE 120 may select the periodicity from a set of retransmission timer periodicities indicated by the network node 110 as described with regard to reference number 510. The UE 120 may determine to use the same change in the periodicity and/or duration of the CG retransmission timer for a HARQ retransmission timer that is associated with the CG and/or a HARQ process. However, in other aspects, the UE 120 may determine a second, different periodicity change and/or second, different duration for the HARQ retransmission timer based at least in part on selecting a change for the CG retransmission timer.

As shown by reference number 550, the UE 120 may transmit, and the network node 110 may receive, an indication of the modification. The indication of the modification may specify any combination of a termination of the CG retransmission timer, a change in a periodicity of the CG retransmission timer, and/or a preferred periodicity change to the CG retransmission timer. For example, the UE 120 may indicate an autonomous periodicity change to, and/or termination of, the CG retransmission timer that has been implemented by the UE 120, or indicate one or more preferred periodicity changes to the CG retransmission timer that the network node 110 may select from as described below.

The UE 120 may transmit the indication of the modification in Layer 1 signaling, Layer 2 signaling, and/or Layer 3 signaling. As an example, the Layer 1 signaling may include UCI and/or CG-UCI. As another example, the Layer 2 signaling may include a medium access control (MAC) control element (CE) and/or the Layer 3 signaling may include an RRC message. The UE 120 may select and/or use a particular type of signaling for transmitting the indication based at least in part on a current CG state. For example, the UE may transmit the indication of the modification in the Layer 1 signaling based at least in part on a first transmission occasion of the CG expiring. That is, the UE may transmit the indication using Layer 1 signaling if the first transmission occasion has passed, which may provide the network node 110 with more time to reallocate future CG occasion resources to other UEs. To illustrate, the Layer 1 signaling may be quicker relative to the Layer 2 and/or Layer 3 signaling such that the network node 110 receives the indication in time to reallocate the resources to another UE.

In some aspects, the UE 120 may determine the modification and/or transmit the indication of the modification based at least in part on an allowed update duration. For example, after selecting a first modification to the CG retransmission timer and transmitting an indication of the first modification, further modifications to the CG retransmission timer may be disallowed. Accordingly, the UE 120 may transmit the first indication of the first modification within the allowed update duration, and refrain from selecting and/or transmitting a second modification associated with the CG retransmission timer within the allowed update duration. That is, the UE 120 will refrain from selecting and/or transmitting a second modification until expiration of the allowed update duration, which may be periodic.

As shown by reference number 560, the network node 110 may reconfigure one or more aspects of the CG, such as a periodicity of the CG retransmission timer associated with the CG and/or a duration of the CG timer. For example, based at least in part on receiving an indication of a modification to the CG retransmission timer as described with regard to reference number 550, the network node 110 may adapt and/or modify a duration associated with the CG timer (e.g., lengthen or shorten) in accordance with the modification to the CG retransmission timer. That is, the network node 110 may transmit a reconfiguration instruction to the UE 120 that indicates to modify the CG timer. Alternatively, or additionally, the network node 110 may reconfigure a duration of the CG retransmission timer based at least in part on the modification indicated by the UE 120. For instance, the UE 120 may indicate one or more preferred periodicity changes to the CG retransmission timer, and the network node 110 may reconfigure the CG retransmission timer (and/or the CG timer) by selecting one of the preferred periodicity changes and transmitting a reconfiguration instruction to the UE 120. In some aspects, the network node 110 may calculate a remaining packet delay budget based at least in part on the modification indicated by the UE 120 and reconfigure the CG retransmission timer (and/or CG timer) for a next uplink CG occasion associated with a retransmission. For example, a nominal packet delay budget of P may be based at least in part on a QoS framework and/or a 5QI value. Alternatively, or additionally, the nominal packet delay budget P may be based at least in part on a protocol data unit (PDU) set delay budget. An experienced delay of D may be observed by the network node 110 (and/or indicated to the network node 110 by the UE 120), and the network node 110 may calculate a remaining packet delay budget as a difference of P-D. The network node 110 may reconfigure the CG retransmission timer and/or the CG timer based at least in part on the difference satisfying a reconfiguration threshold.

However, in other aspects, the UE 120 may autonomously modify the CG retransmission timer and without a reconfiguration instruction from the network node 110.

As shown by reference number 570, the network node 110 and the UE 120 may communicate with one another based at least in part on the modification. As one example, the UE 120 may apply a CG retransmission timer duration modification to the CG retransmission timer, and transmit one or more retransmissions based at least in part on the CG retransmission timer duration modification. Alternatively, or additionally, the UE 120 may apply a CG timer duration modification as described above. In some aspects, the UE 120 may also apply the CG retransmission timer duration modification to a HARQ retransmission timer that is associated with a HARQ process and the CG. However, in other aspects, the modification to the CG retransmission timer duration may be independent and/or different from a modification to the HARQ retransmission timer duration.

As described above, the UE 120 may determine to shorten or increase a duration to a periodicity of the CG retransmission timer. In some aspects, the UE 120 may implicitly indicate a lengthening to the periodicity by changing a decrement factor of the CG retransmission timer. As one example, the UE 120 may increase the periodicity of the CG retransmission timer by decrementing the CG retransmission timer based at least in part on one or more uplink occasions of the CG and refraining from decrementing the configured grant retransmission timer based at least in part on one or more downlink occasions. Alternatively, or additionally, the UE 120 may use a periodicity selected from the set of retransmission timer periodicities, and the network node 110 may blindly decode the periodicity by monitoring a duration between retransmissions. The UE 120 may indicate that the CG retransmission timer may be modified, may be disabled, has been disabled (e.g., by the UE 120), and/or has been modified (e.g., by the UE 120) by setting a field in UCI and/or CG-UCI.

As shown by reference number 580, the UE 120 may iteratively detect an operating change and/or iteratively determine a modification to the CG retransmission timer. To illustrate, the UE 120 may detect, as an operating change, deactivation of a voice call, deactivation of an augmented reality mode, deactivation of a virtual reality mode, and/or deactivation of a navigation mode that results in a latency bound increasing. The UE 120 may calculate and/or generate an updated latency threshold based at least in part on detecting the operating change (e.g., an updated latency threshold that indicates tolerance for a longer uplink data transfer latency). The UE may calculate the remaining uplink delay budget described above, determine that the remaining uplink delay budget satisfies the updated latency threshold, and determine as a modification, an increase to the periodicity of the CG retransmission timer. Accordingly, and based at least in part on iteratively determining a modification, the UE 120 may transmit an indication of the (updated) modification to the network node 110 and/or communicate with the network node 110 based at least in part on the (updated) modification to the CG retransmission timer and the CG.

As shown by reference number 590, the network node 110 may reallocate one or more air interface resources associated with the CG to a second UE (e.g., another UE 120). For example, the UE may indicate a termination of the CG reconfiguration timer, and the network node 110 may reallocate one or more air interface resources associated with the CG, such as air interface resource(s) associated with an uplink occasion for a retransmission, to another UE. The reallocation of the air interface resource(s) may increase data throughput and/or reduce data transfer latencies within the wireless network based at least in part on the network node 110 having more air interface resource(s) available sooner for other UEs (e.g., relative to not reallocating the unused CG resources). Alternatively, or additionally, by autonomously modifying a CG retransmission timer and/or autonomously requesting a modification to the CG retransmission timer, the UE 120 may mitigate an uplink transmission delay that exceeds a data transfer latency bound for operations that may be time sensitive. Accordingly, mitigating the uplink transmission delay may enable the UE to meet the data transfer latency bound and support time sensitive operations.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with a UE modification to a configured grant retransmission timer.

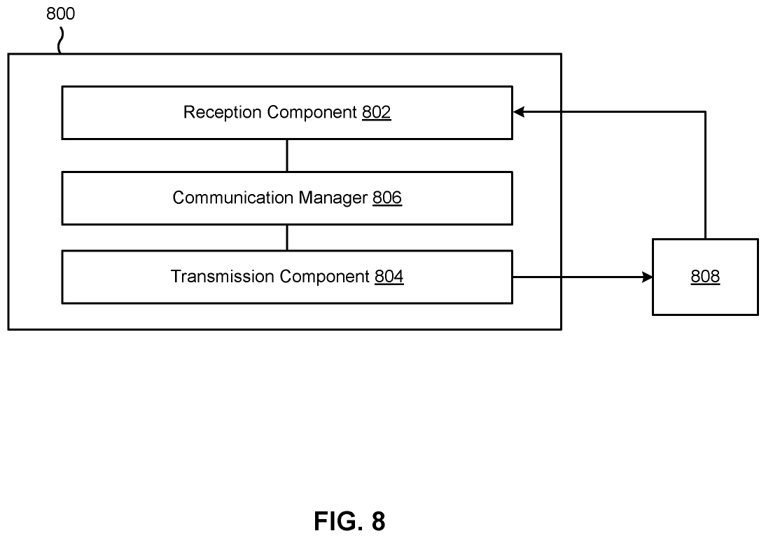

As shown in FIG. 6, in some aspects, process 600 may include receiving a first indication of a configuration for a configured grant retransmission timer that is associated with a configured grant assigned to the UE (block 610). For example, the UE (e.g., using reception component 802 and/or communication manager 806, depicted in FIG. 8) may receive a first indication of a configuration for a configured grant retransmission timer that is associated with a configured grant assigned to the UE, as described above.

As further shown in FIG. 6, in some aspects, process 600 may include determining a modification to the configuration for the configured grant retransmission timer based at least in part on a remaining uplink delay budget (block 620). For example, the UE (e.g., using communication manager 806, depicted in FIG. 8) may determine a modification to the configuration for the configured grant retransmission timer based at least in part on a remaining uplink delay budget, as described above.

As further shown in FIG. 6, in some aspects, process 600 may include transmitting a second indication of the modification (block 630). For example, the UE (e.g., using transmission component 804 and/or communication manager 806, depicted in FIG. 8) may transmit a second indication of the modification, as described above.

Process 600 may include additional aspects, such as any single aspect or any combination of aspects described below and/or in connection with one or more other processes described elsewhere herein.

In a first aspect, the second indication is indicated in at least one of UCI or CG-UCI.

In a second aspect, determining the modification based at least in part on the remaining uplink delay budget includes determining that the remaining uplink delay budget fails to satisfy a latency threshold.

In a third aspect, the modification includes termination of the configured grant retransmission timer.

In a fourth aspect, the modification includes a change to a periodicity of the configured grant retransmission timer.

In a fifth aspect, the change the periodicity of the configured grant retransmission timer includes at least one of shortening a duration of the periodicity, or lengthening the duration of the periodicity.

In a sixth aspect, the modification includes skipping one or more uplink occasions associated with the configured grant.

In a seventh aspect, transmitting the first indication of the modification includes transmitting the first indication in at least one of Layer 1 signaling, Layer 2 signaling, or Layer 3 signaling.

In an eighth aspect, transmitting the first indication of the modification includes transmitting the first indication of the modification in the Layer 1 signaling based at least in part on transmitting the first indication after a first transmission occasion of the configured grant.

In a ninth aspect, the Layer 1 signaling includes uplink control information.

In a tenth aspect, the Layer 2 signaling includes a MAC CE.

In an eleventh aspect, the Layer 3 signaling includes a RRC message.

In a twelfth aspect, transmitting the first indication of the modification includes transmitting the first indication of the modification based at least in part on an allowed update duration.

In a thirteenth aspect, the modification is a first modification, transmitting the first indication of the modification includes transmitting the first indication of the first modification within the allowed update duration, and process 600 includes refraining from transmitting a second modification associated with the configured grant retransmission timer within the allowed update duration.

In a fourteenth aspect, the allowed update duration is periodic.

In a fifteenth aspect, process 600 includes calculating an uplink latency, and determining that the uplink latency fails to satisfy a latency threshold, and determining the modification includes determining, as the modification, to disable the configured grant retransmission timer based at least in part on the uplink latency failing to satisfy the latency threshold.

In a sixteenth aspect, calculating the uplink latency is based at least in part on an experienced uplink latency value.

In a seventeenth aspect, calculating the uplink latency is based at least in part on a minimum delay associated with two or more logical channels.

In an eighteenth aspect, the configuration for the configured grant retransmission timer includes a first retransmission timer periodicity, and process 600 includes receiving a set of retransmission timer periodicities, and selecting, from the set of retransmission timer periodicities and as the modification, a second retransmission timer periodicity.

In a nineteenth aspect, the modification includes a timer duration modification, and process 600 includes applying the timer duration modification to the configured grant retransmission timer and a HARQ retransmission timer that is associated with a HARQ process and the configured grant.

In a twentieth aspect, the modification is a first modification, and process 600 includes determining a second modification to a HARQ retransmission timer based at least in part on determining the first modification.

In a twenty-first aspect, process 600 includes receiving a second configuration that is associated with a configured grant timer, the second configuration is based at least in part on the modification, and the configured grant timer is associated with the configured grant.

In a twenty-second aspect, process 600 includes generating an updated latency threshold based at least in part on a change at the UE, determining that the remaining uplink delay budget satisfies the updated latency threshold, and increasing a periodicity of the configured grant retransmission timer.

In a twenty-third aspect, the change includes an update to at least one QoS configuration associated with a QoS flow.

In a twenty-fourth aspect, increasing the periodicity includes increasing the periodicity implicitly and based at least in part on changing a decrement factor of the configured grant retransmission timer.

In a twenty-fifth aspect, changing the decrement factor includes decrementing the configured grant retransmission timer based at least in part on one or more uplink occasions, and refraining from decrementing the configured grant retransmission timer based at least in part on one or more downlink occasions.

In a twenty-sixth aspect, process 600 includes using the configured grant retransmission timer without using a HARQ retransmission timer.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with a UE modification to a configured grant retransmission timer.

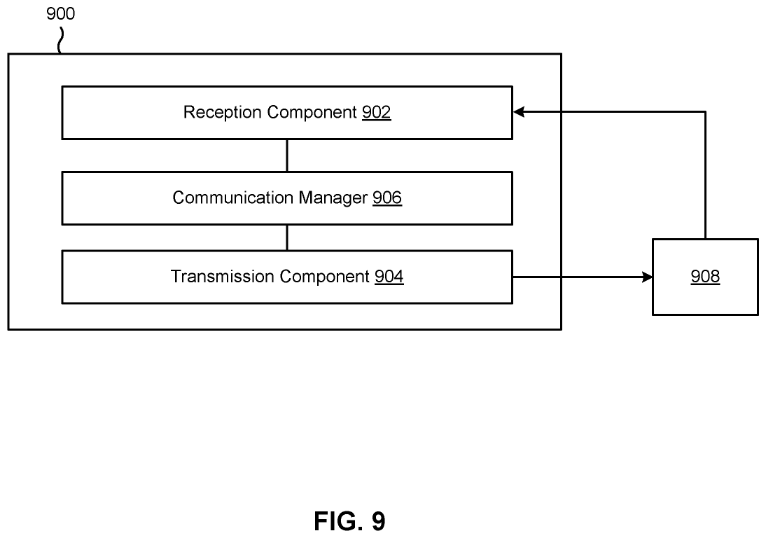

As shown in FIG. 7, in some aspects, process 700 may include transmitting a first indication of a configuration for a configured grant retransmission timer that is associated with a configured grant assigned to a UE (block 710). For example, the network node (e.g., using transmission component 904 and/or communication manager 906, depicted in FIG. 9) may transmit a first indication of a configuration for a configured grant retransmission timer that is associated with a configured grant assigned to a UE, as described above.

As further shown in FIG. 7, in some aspects, process 700 may include receiving a second indication of a modification to the configuration for the configured grant retransmission timer (block 720). For example, the network node (e.g., using reception component 902 and/or communication manager 906, depicted in FIG. 9) may receive a second indication of a modification to the configuration for the configured grant retransmission timer, as described above.

Process 700 may include additional aspects, such as any single aspect or any combination of aspects described below and/or in connection with one or more other processes described elsewhere herein.

In a first aspect, process 700 includes reallocating one or more air interface resources associated with the configured grant to a second UE.

In a second aspect, the modification includes disabling the configured grant retransmission timer.

In a third aspect, the modification includes a change to a periodicity of the configured grant retransmission timer.

In a fourth aspect, the change to the periodicity of the configured grant retransmission timer includes at least one of shortening a duration of the periodicity, or lengthening the duration of the periodicity.

In a fifth aspect, the modification includes at least one of an early termination of the configured grant retransmission timer, or skipping one or more uplink occasions associated with the configured grant.

In a sixth aspect, receiving the first indication of the modification includes receiving the first indication in at least one of Layer 1 signaling, Layer 2 signaling, or Layer 3 signaling.

In a seventh aspect, receiving the first indication of the modification includes receiving the first indication of the modification in the Layer 1 signaling after a first transmission occasion of the configured grant.

In an eighth aspect, process 700 includes transmitting a set of retransmission timer periodicities, and receiving, as the second indication of the modification, a second retransmission timer periodicity that is included in the set of retransmission timer periodicities.

In a ninth aspect, process 700 includes determining a second configuration that is associated with a configured grant timer, the second configuration being based at least in part on the modification, the configured grant timer being associated with the configured grant, and transmitting a third indication of the second configuration.

In a tenth aspect, the modification indicates a request to terminate the configured grant retransmission timer, and process 700 includes configuring a second configured grant assigned to the UE that adjusts the configuration of the configured grant retransmission timer.

In an eleventh aspect, process 700 includes configuring the configured grant retransmission timer without configuring a HARQ retransmission timer.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-7. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a first indication of a configuration for a configured grant retransmission timer that is associated with a configured grant assigned to the UE. The communication manager 806 may determine a modification to the configuration for the configured grant retransmission timer based at least in part on a remaining uplink delay budget. The transmission component 804 may transmit a second indication of the modification.

The communication manager 806 may calculate an uplink latency.

The communication manager 806 may determine that the uplink latency fails to satisfy a latency threshold.

The reception component 802 may receive a second configuration that is associated with a configured grant timer, the second configuration being based at least in part on the modification, the configured grant timer being associated with the configured grant.

The communication manager 806 may generate an updated latency threshold based at least in part on a change at the UE.

The communication manager 806 may determine that the remaining uplink delay budget satisfies the updated latency threshold.

The communication manager 806 may increase a periodicity of the configured grant retransmission timer.

The communication manager 806 may use the configured grant retransmission timer without using a HARQ retransmission timer.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-7. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit a first indication of a configuration for a configured grant retransmission timer that is associated with a configured grant assigned to a UE. The reception component 902 may receive a second indication of a modification to the configuration for the configured grant retransmission timer.

The transmission component 904 may transmit a set of retransmission timer periodicities.

The reception component 902 may receive, as the second indication of the modification, a second retransmission timer periodicity that is included in the set of retransmission timer periodicities.

The communication manager 906 may determine a second configuration that is associated with a configured grant timer, the second configuration being based at least in part on the modification, the configured grant timer being associated with the configured grant.

The transmission component 904 may transmit a third indication of the second configuration.

The communication manager 906 may configure the configured grant retransmission timer without configuring a HARQ retransmission timer.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving a first indication of a configuration for a configured grant retransmission timer that is associated with a configured grant assigned to the UE; determining a modification to the configuration for the configured grant retransmission timer based at least in part on a remaining uplink delay budget; and transmitting a second indication of the modification.

Aspect 2: The method of Aspect 1, wherein the second indication is indicated in at least one of: uplink control information (UCI), or configured grant-uplink control information (CG-UCI).

Aspect 3: The method of any of Aspects 1-2, wherein determining the modification based at least in part on the remaining uplink delay budget comprises: determining that the remaining uplink delay budget fails to satisfy a latency threshold.

Aspect 4: The method of any of Aspects 1-3, wherein the modification includes termination of the configured grant retransmission timer.

Aspect 5: The method of any of Aspects 1-4, wherein the modification includes a change to a periodicity of the configured grant retransmission timer.

Aspect 6: The method of Aspect 5, wherein the change the periodicity of the configured grant retransmission timer includes at least one of: shortening a duration of the periodicity, or lengthening the duration of the periodicity.

Aspect 7: The method of any of Aspects 1-6, wherein the modification includes skipping one or more uplink occasions associated with the configured grant.

Aspect 8: The method of any of Aspects 1-7, wherein transmitting the first indication of the modification includes transmitting the first indication in at least one of: Layer 1 signaling, Layer 2 signaling, or Layer 3 signaling.

Aspect 9: The method of Aspect 8, wherein transmitting the first indication of the modification includes: transmitting the first indication of the modification in the Layer 1 signaling based at least in part on transmitting the first indication after a first transmission occasion of the configured grant.

Aspect 10: The method of Aspect 8, wherein the Layer 1 signaling includes uplink control information.

Aspect 11: The method of Aspect 8, wherein the Layer 2 signaling includes a medium access control (MAC) control element (CE).

Aspect 12: The method of Aspect 8, wherein the Layer 3 signaling includes a radio resource control (RRC) message.

Aspect 13: The method of any of Aspects 1-12, wherein transmitting the first indication of the modification includes: transmitting the first indication of the modification based at least in part on an allowed update duration.

Aspect 14: The method of Aspect 13, wherein the modification is a first modification, wherein transmitting the first indication of the modification includes: transmitting the first indication of the first modification within the allowed update duration, and wherein the method further comprises: refraining from transmitting a second modification associated with the configured grant retransmission timer within the allowed update duration.

Aspect 15: The method of Aspect 13, wherein the allowed update duration is periodic.

Aspect 16: The method of any of Aspects 1-15, further comprising: calculating an uplink latency; and determining that the uplink latency fails to satisfy a latency threshold, wherein determining the modification includes: determining, as the modification, to disable the configured grant retransmission timer based at least in part on the uplink latency failing to satisfy the latency threshold. In some aspects, determining the modification includes: determining, as the modification, to disable the configured grant retransmission timer based at least in part on the uplink latency failing to satisfy the latency threshold.

Aspect 17: The method of Aspect 16, wherein calculating the uplink latency is based at least in part on an experienced uplink latency value.

Aspect 18: The method of Aspect 16, wherein calculating the uplink latency is based at least in part on a minimum delay associated with two or more logical channels.

Aspect 19: The method of any of Aspects 1-18, wherein the configuration for the configured grant retransmission timer includes a first retransmission timer periodicity, and wherein the method further comprises: receiving a set of retransmission timer periodicities; and selecting, from the set of retransmission timer periodicities and as the modification, a second retransmission timer periodicity.

Aspect 20: The method of any of Aspects 1-19, wherein the modification includes a timer duration modification, and the method further comprises: applying the timer duration modification to the configured grant retransmission timer and a hybrid automatic repeat request (HARQ) retransmission timer that is associated with a HARQ process and the configured grant.

Aspect 21: The method of any of Aspects 1-20, wherein the modification is a first modification, and the method further comprises: determining a second modification to a hybrid automatic repeat request (HARQ) retransmission timer based at least in part on determining the first modification.

Aspect 22: The method of any of Aspects 1-21, further comprising: receiving a second configuration that is associated with a configured grant timer, the second configuration being based at least in part on the modification, the configured grant timer being associated with the configured grant.

Aspect 23: The method of any of Aspects 1-22, further comprising: generating an updated latency threshold based at least in part on a change at the UE; determining that the remaining uplink delay budget satisfies the updated latency threshold; and increasing a periodicity of the configured grant retransmission timer.

Aspect 24: The method of Aspect 23, wherein the change comprises an update to at least one Quality-of-Service (QoS) configuration associated with a QoS flow.

Aspect 25: The method of Aspect 23, wherein increasing the periodicity includes: increasing the periodicity implicitly and based at least in part on changing a decrement factor of the configured grant retransmission timer.

Aspect 26: The method of Aspect 25, wherein changing the decrement factor includes: decrementing the configured grant retransmission timer based at least in part on one or more uplink occasions; and refraining from decrementing the configured grant retransmission timer based at least in part on one or more downlink occasions.

Aspect 27: The method of any of Aspects 1-26, further comprising: using the configured grant retransmission timer without using a hybrid automatic repeat request (HARQ) retransmission timer.

Aspect 28: A method of wireless communication performed by a network node, comprising: transmitting a first indication of a configuration for a configured grant retransmission timer that is associated with a configured grant assigned to a user equipment (UE); and receiving a second indication of a modification to the configuration for the configured grant retransmission timer.

Aspect 29: The method of Aspect 28, wherein the method further comprises: reallocating one or more air interface resources associated with the configured grant to a second UE.

Aspect 30: The method of any of Aspects 28-29, wherein the modification includes disabling the configured grant retransmission timer.

Aspect 31: The method of any of Aspects 28-30, wherein the modification includes a change to a periodicity of the configured grant retransmission timer.

Aspect 32: The method of Aspect 31, wherein the change to the periodicity of the configured grant retransmission timer includes at least one of: shortening a duration of the periodicity, or lengthening the duration of the periodicity.

Aspect 33: The method of any of Aspects 28-32, wherein the modification includes at least one of: an early termination of the configured grant retransmission timer, or skipping one or more uplink occasions associated with the configured grant.

Aspect 34: The method of any of Aspects 28-33, wherein receiving the first indication of the modification includes receiving the first indication in at least one of: Layer 1 signaling, Layer 2 signaling, or Layer 3 signaling.

Aspect 35: The method of Aspect 34, wherein receiving the first indication of the modification includes: receiving the first indication of the modification in the Layer 1 signaling after a first transmission occasion of the configured grant.

Aspect 36: The method of any of Aspects 28-35, further comprising: transmitting a set of retransmission timer periodicities; and receiving, as the second indication of the modification, a second retransmission timer periodicity that is included in the set of retransmission timer periodicities.

Aspect 37: The method of any of Aspects 28-36, further comprising: determining a second configuration that is associated with a configured grant timer, the second configuration being based at least in part on the modification, the configured grant timer being associated with the configured grant; and transmitting a third indication of the second configuration.

Aspect 38: The method of any of Aspects 28-37, wherein the modification indicates a request to terminate the configured grant retransmission timer; and the method further comprises: configuring a second configured grant assigned to the UE that adjusts the configuration of the configured grant retransmission timer.

Aspect 39: The method of any of Aspects 28-38, further comprising: configuring the configured grant retransmission timer without configuring a hybrid automatic repeat request (HARQ) retransmission timer.

Aspect 40: An apparatus for wireless communication at a device, comprising a processor; memory coupled with the processor; and instructions stored in the memory and executable by the processor to cause the apparatus to perform the method of one or more of Aspects 1-27.

Aspect 41: An apparatus for wireless communication at a device, comprising a processor; memory coupled with the processor; and instructions stored in the memory and executable by the processor to cause the apparatus to perform the method of one or more of Aspects 28-39.

Aspect 42: A device for wireless communication, comprising a memory and one or more processors coupled to the memory, the one or more processors configured to perform the method of one or more of Aspects 1-27.

Aspect 43: A device for wireless communication, comprising a memory and one or more processors coupled to the memory, the one or more processors configured to perform the method of one or more of Aspects 28-39.

Aspect 44: An apparatus for wireless communication, comprising at least one means for performing the method of one or more of Aspects 1-27.

Aspect 45: An apparatus for wireless communication, comprising at least one means for performing the method of one or more of Aspects 28-39.

Aspect 46: A non-transitory computer-readable medium storing code for wireless communication, the code comprising instructions executable by a processor to perform the method of one or more of Aspects 1-27.

Aspect 47: A non-transitory computer-readable medium storing code for wireless communication, the code comprising instructions executable by a processor to perform the method of one or more of Aspects 28-39.

Aspect 48: A non-transitory computer-readable medium storing a set of instructions for wireless communication, the set of instructions comprising one or more instructions that, when executed by one or more processors of a device, cause the device to perform the method of one or more of Aspects 1-27.

Aspect 49: A non-transitory computer-readable medium storing a set of instructions for wireless communication, the set of instructions comprising one or more instructions that, when executed by one or more processors of a device, cause the device to perform the method of one or more of Aspects 28-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a first indication of a configuration for a configured grant retransmission timer that is associated with a configured grant assigned to the UE;
determine a modification to the configuration for the configured grant retransmission timer based at least in part on a remaining uplink delay budget; and
transmit a second indication of the modification.

2. The apparatus of claim 1, wherein the second indication is indicated in at least one of:
uplink control information (UCI), or
configured grant-uplink control information (CG-UCI).

3. The apparatus of claim 1, wherein the one or more processors, to determine the modification based at least in part on the remaining uplink delay budget, are configured to:
determine that the remaining uplink delay budget fails to satisfy a latency threshold.

4. The apparatus of claim 1, wherein the modification includes termination of the configured grant retransmission timer.

5. The apparatus of claim 1, wherein the modification includes a change to a periodicity of the configured grant retransmission timer.

6. The apparatus of claim 1, wherein the one or more processors, to transmit the first indication of the modification, are configured to:
transmit the first indication of the modification based at least in part on an allowed update duration.

7. The apparatus of claim 1, wherein the one or more processors are further configured to:
calculate an uplink latency; and
determine that the uplink latency fails to satisfy a latency threshold,
wherein the one or more processors, to determine the modification, are configured to:
determine, as the modification, to disable the configured grant retransmission timer based at least in part on the uplink latency failing to satisfy the latency threshold.

8. The apparatus of claim 1, wherein the configuration for the configured grant retransmission timer includes a first retransmission timer periodicity, and wherein the one or more processors are further configured to:
receive a set of retransmission timer periodicities; and
select, from the set of retransmission timer periodicities and as the modification, a second retransmission timer periodicity.

9. The apparatus of claim 1, wherein the one or more processors are further configured to:
receive a second configuration that is associated with a configured grant timer, the second configuration being based at least in part on the modification, the configured grant timer being associated with the configured grant.

10. The apparatus of claim 1, wherein the one or more processors are further configured to:
generate an updated latency threshold based at least in part on an operating change at the UE;
determine that the remaining uplink delay budget satisfies the updated latency threshold; and
increase a periodicity of the configured grant retransmission timer.

11. An apparatus for wireless communication at a network node, comprising:
a memory; and
one or more processors, coupled to the memory, configured to:
transmit a first indication of a configuration for a configured grant retransmission timer that is associated with a configured grant assigned to a user equipment (UE); and
receive a second indication of a modification to the configuration for the configured grant retransmission timer.

12. The apparatus of claim 11, wherein the one or more processors are further configured to:
reallocate one or more air interface resources associated with the configured grant to a second UE.

13. The apparatus of claim 11, wherein the one or more processors are further configured to disable the configured grant retransmission timer.

14. The apparatus of claim 11, wherein the modification includes a change to a periodicity of the configured grant retransmission timer.

15. The apparatus of claim 11, wherein the one or more processors, to receive the first indication of the modification, are configured to receive the first indication in at least one of:
Layer 1 signaling,
Layer 2 signaling, or
Layer 3 signaling.

16. The apparatus of claim 11, wherein the one or more processors are further configured to:
transmit a set of retransmission timer periodicities; and
receive, as the second indication of the modification, a second retransmission timer periodicity that is included in the set of retransmission timer periodicities.

17. The apparatus of claim 11, wherein the one or more processors are further configured to:
determine a second configuration that is associated with a configured grant timer, the second configuration being based at least in part on the modification, the configured grant timer being associated with the configured grant; and
transmit a third indication of the second configuration.

18. The apparatus of claim 11, wherein the one or more processors are further configured to:
configure a second configured grant assigned to the UE that adjusts the configuration of the configured grant retransmission timer.

19. A method of wireless communication performed by a user equipment (UE), comprising:
receiving a first indication of a configuration for a configured grant retransmission timer that is associated with a configured grant assigned to the UE;
determining a modification to the configuration for the configured grant retransmission timer based at least in part on a remaining uplink delay budget; and
transmitting a second indication of the modification.

20. The method of claim 19, wherein determining the modification based at least in part on the remaining uplink delay budget comprises:
determining that the remaining uplink delay budget fails to satisfy a latency threshold.

21. The method of claim 19, wherein the modification includes at least one of:
a termination of the configured grant retransmission timer,
a change to a periodicity of the configured grant retransmission timer.

22. The method of claim 19, wherein transmitting the first indication of the modification includes:
transmitting the first indication of the modification based at least in part on an allowed update duration.

23. The method of claim 19, wherein the configuration for the configured grant retransmission timer includes a first retransmission timer periodicity, and wherein the method further comprises:
receiving a set of retransmission timer periodicities; and
selecting, from the set of retransmission timer periodicities and as the modification, a second retransmission timer periodicity.

24. The method of claim 19, wherein the modification includes a timer duration modification, and the method further comprises:
applying the timer duration modification to the configured grant retransmission timer and a hybrid automatic repeat request (HARQ) retransmission timer that is associated with a HARQ process and the configured grant.

25. The method of claim 19, wherein the modification is a first modification, and the method further comprises:
determining a second modification to a hybrid automatic repeat request (HARQ) retransmission timer based at least in part on determining the first modification.

26. The method of claim 19, further comprising:
receiving a second configuration that is associated with a configured grant timer, the second configuration being based at least in part on the modification, the configured grant timer being associated with the configured grant.

27. A method of wireless communication performed by a network node, comprising:
transmitting a first indication of a configuration for a configured grant retransmission timer that is associated with a configured grant assigned to a user equipment (UE); and
receiving a second indication of a modification to the configuration for the configured grant retransmission timer.

28. The method of claim 27, wherein the method further comprises:
reallocating one or more air interface resources associated with the configured grant to a second UE.

29. The method of claim 27, wherein receiving the first indication of the modification includes:
receiving the first indication of the modification in Layer 1 signaling after a first transmission occasion of the configured grant.

30. The method of claim 27, further comprising:
determining a second configuration that is associated with a configured grant timer, the second configuration being based at least in part on the modification, the configured grant timer being associated with the configured grant; and
transmitting a third indication of the second configuration.
